(19) United States
(12) Patent Application Publication
(10) Pub. No.: US 2012/0311090 A1
(43) Pub. Date: Dec. 6, 2012

(54) SYSTEMS AND METHODS FOR AGGREGATING AUDIO INFORMATION FROM MULTIPLE SOURCES

(75) Inventors: Howard Locker, Cary, NC (US); Jay Wesley Johnson, Raleigh, NC (US); Masayuki Kumagai, Kanagawa-Pref. (JP)

(73) Assignee: Lenovo (Singapore) Pte. Ltd., Singapore (SG)

(21) Appl. No.: 13/149,040

(22) Filed: May 31, 2011

(51) Int. Cl. G06F 15/16

(52) U.S. Cl. 709/218

(57) ABSTRACT

Described herein are methods, systems, apparatuses and products providing an audio stream generated on a central information handling device from mixing a collection of audio streams captured at external audio capturing devices. An aspect provides for running a host audio aggregation application on an information handling device, the host audio aggregation application being configured to obtain audio transmitted by at least one secondary audio device external to the information handling device; generating at least one central audio stream via the host aggregation application by mixing the audio transmitted by the at least one secondary audio device and obtained by the host audio aggregation application; wherein the host aggregation application is configured to send the at least one central audio stream to one or more audio receivers.

### BACKGROUND

Remote conferencing allows individuals located at different locations to participate in the exchange of information under real time conditions. There are many forms of remote conferencing, with teleconferencing, video conferencing, and web conferencing being the main types. Although the different forms may involve the sharing or exchange of different information, including video, images, files, white board and computer screen images, all of them usually are accompanied by the exchange of audio information. In teleconferencing, audio data essentially comprises all of the data exchanged by remote participants. For other remote conferencing types, sound also plays a central part, as it makes the remote conference a more efficient and cohesive event.

Remote conferencing equipment has long been available in the marketplace that is especially designed for exchanging information and audio with multiple conference participants. However, such equipment is expensive, lacks portability, and, especially in the current technological climate, soon becomes obsolete. A modern trend involves using notebook computers as remote conferencing devices along with specialized software. Although such use of notebook computers may solve a few of the problems concerning specialized remote conferencing equipment, many shortcomings currently remain.

### BRIEF SUMMARY

In summary, one aspect provides a system comprising: a host audio aggregation application running on an information handling device and being configured to obtain audio transmitted by at least one secondary audio device external to the information handling device; and at least one central audio stream generated by the host aggregation application by mixing the audio transmitted by the at least one secondary audio device and obtained by the host audio aggregation application: wherein the host aggregation application is configured to send the at least one central audio stream to at least one audio receiver.

Another aspect provides a method comprising: running a host audio aggregation application on an information handling device, the host audio aggregation application being configured to obtain audio transmitted by at least one secondary audio device external to the information handling device; generating at least one central audio stream via the host aggregation application by mixing the audio transmitted by the at least one secondary audio device and obtained by the host audio aggregation application; wherein the host aggregation application is configured to send the at least one central audio stream to one or more audio receivers.

A further aspect provides a computer program product comprising: a computer readable storage medium having computer readable program code embodied therewith, the computer readable program code comprising: computer readable program code configured to run a host audio aggregation application on an information handling device, the host audio aggregation application being configured to obtain audio transmitted by at least one secondary audio device external to the information handling device; computer readable program code configured to generating at least one central audio stream via the host aggregation application by mixing the audio transmitted by the at least one secondary audio device and obtained by the host audio aggregation application; and computer readable program code configured to send the at least one central audio stream to one or more audio receivers via the host audio aggregation application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 provides an example remote conference according to an embodiment.

FIG. 2 provides an example of an information handling device and multiple secondary audio devices, running respective software applications, according to an embodiment.

FIG. 3 provides an example flow diagram of audio aggregation software operation according to an embodiment.

FIG. 4 illustrates an example circuitry of a computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obscuring aspects of the invention.

Notebook computers may be used to participate in and host remote conferences, for example, using Voice over Internet Protocol (VoIP), which provides for the transmission of voice and multimedia data over Internet Protocol (IP) networks, such as the Internet. Typically, notebook computers participate in VoIP conference calls using specialized software, such as Skype® and GoToMeeting®. Skype is a registered trademark of Skype Limited in the United States and other countries. GoToMeeting is a registered trademark of Citrix Online, LLC. The ability to use notebook computers, and other portable information handling devices, as remote conferencing equipment has many advantages, such as cost, flexibility in conference participation location, and ease of use. In addition, when sharing data, it is advantageous for conference participants to be able to access files and applications using a familiar device.

When active in a remote conference, the notebook computer microphone is used to capture audio for transmission to the other conference participants. Using the notebook computer microphone to capture conference audio may work well for a single user positioned in front of the notebook computer. However, this configuration does not provide adequate audio capture for multiple users, such as a group of users positioned around a conference table. As such, using existing technology, remote conferences involving multiple participants and hosted by notebook computers, or other such portable computing devices, suffer from poor audio quality.

Embodiments provide methods and systems for arranging audio collected from multiple sources into a comprehensive audio stream. According to embodiments, an information handling device may collect audio data captured by one or more secondary audio devices. In addition, embodiments provide that an information handling device may aggregate the collected audio data into a central audio data arrangement. Furthermore, an information handling device according to embodiments may stream the collected audio data as one or more audio streams, for example, through device speakers or as audio input to one or more applications, including, but not limited to, a remote conferencing application using VoIP.

According to embodiments, a secondary audio device may capture audio using a device microphone, and an audio aggregation application running on the secondary audio device may obtain the captured audio data and send it to an information handling device. As a non-limiting example, a secondary audio device may send the captured audio data to an information handling device wirelessly, such as through WLAN (e.g., Wi-Fi) or PAN (e.g., Bluetooth). Embodiments provide that an audio aggregation application running on an information handling device may capture audio data sent from one or more secondary audio devices and process the audio data as one or more audio streams. According to embodiments, the information handling device audio aggregation application may be an independent application, a device driver module, or an extension of existing software running on the information handling device. As a non-limiting example, an audio aggregation application according to embodiments may communicate with the information handling device audio driver such that the application may mix the input from the information handling device microphone with the audio received from secondary audio devices and send it to existing applications as the information handling device microphone output.

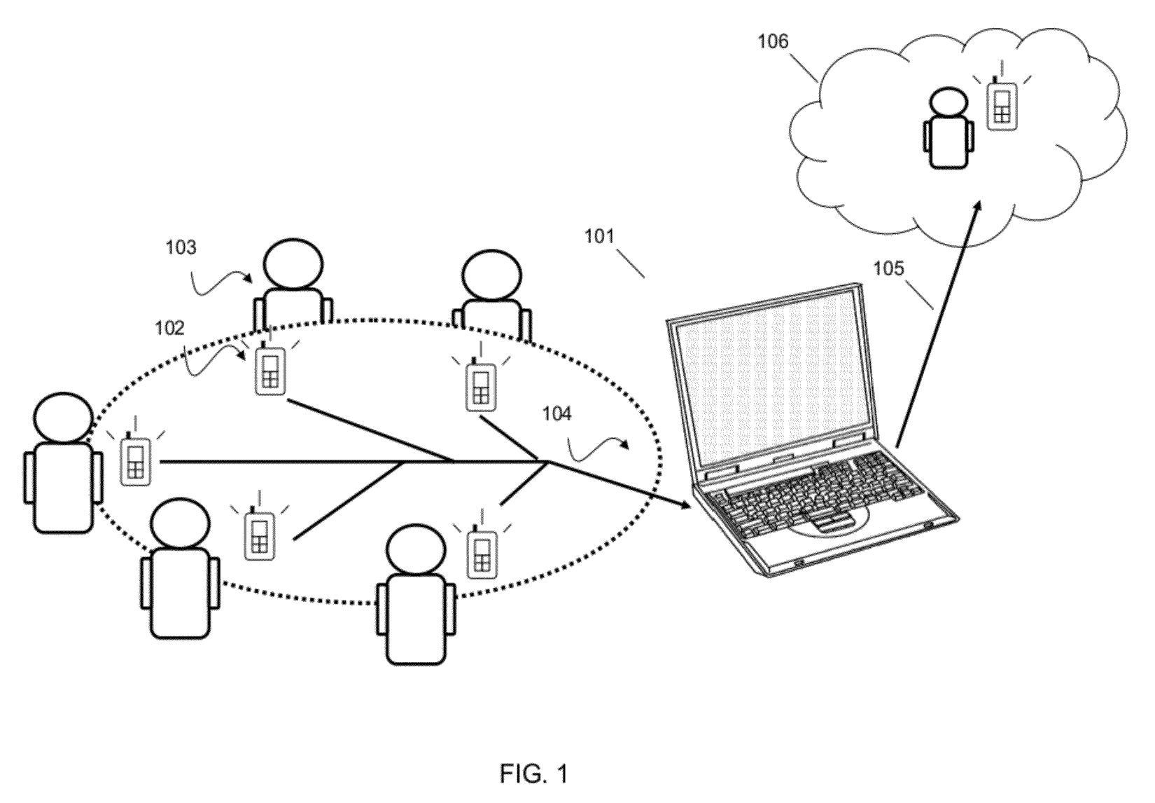

Referring to FIG. 1, therein is depicted an example remote conference according to an embodiment. A notebook computer 101 running teleconferencing software is in communication with multiple smart phones 102 through Bluetooth. The smart phones 102 capture sound from their respective users 103 through a microphone. An audio acquiring application running on each smart phone 102 acquires the sound captured by the microphone and transmits it 104 as audio data to the notebook computer 101 through Bluetooth. The notebook computer 101 receives the audio data and mixes it with sound captured by the notebook computer microphone, if necessary, and sends 105 the mixed audio data as a single audio stream to a receiver, which in the example shown in FIG. 1, is teleconferencing software. A remote teleconferencing participant 106 receives the mixed audio data as a single audio stream through the corresponding teleconferencing software on his information handling device. As such, to the remote participant 106, the sound data from the multiple users 103 is received as one comprehensive audio stream. In addition, the audio quality of sound from the multiple users 103 is comprised of quality audio data as though the audio stream was being transmitted directly from their respective smart phones 102.

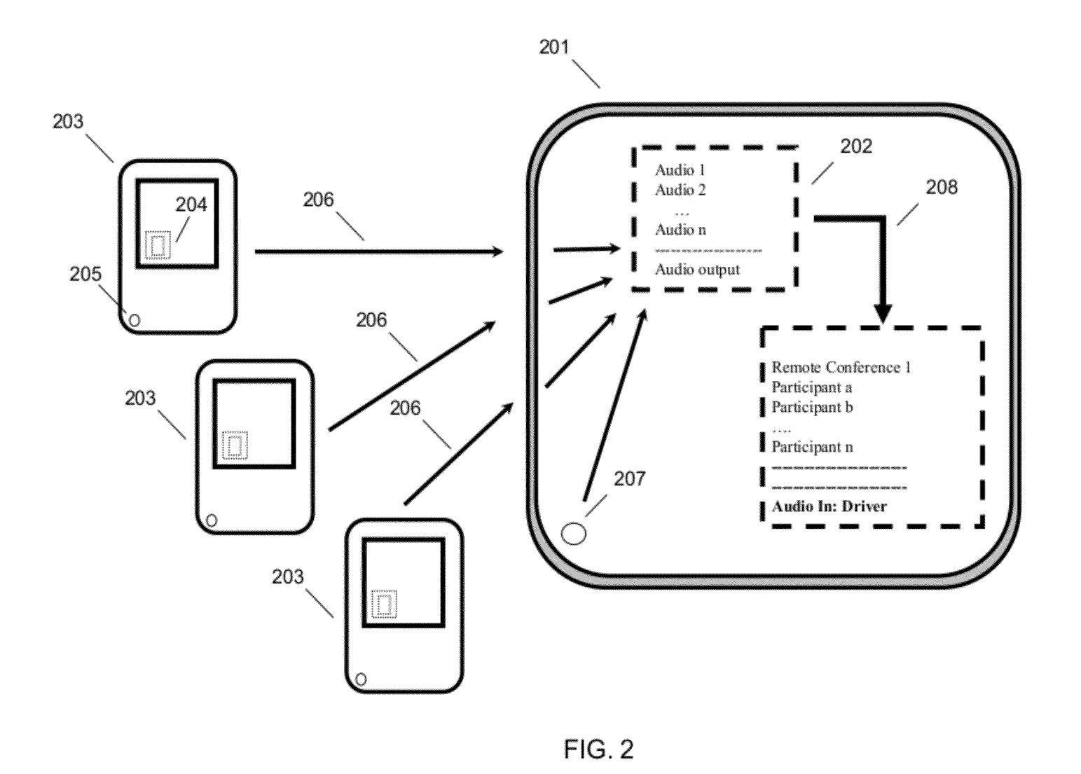

FIG. 2 illustrates an example of an information handling device and multiple secondary audio devices, running respective software applications, according to an embodiment. An information handling device 201 is running an audio stream aggregation application 202, while secondary audio devices 203 are running instances of an audio capture application 204. As a non-limiting example, the audio capture application 204 may be a standalone application associated with the audio stream aggregation application 202, or it may be a client configuration of the audio stream aggregation application 204. The secondary audio devices 203 each have a microphone 205 for capturing sound. The audio capture application 204 receives sound captured by the microphone 205 and transmits the sound as an audio stream 206 to the information handling device 201, where it is ultimately acquired by the audio stream aggregation application 202.

The information handling device 201 may have a microphone 207 for capturing external sound. The external sound captured by the microphone 207 of the information handling device 201 may also, but not necessarily, be sent to the audio stream aggregation application 202. The audio data received by the audio stream aggregation application 202 is processed, including, but not limited to, by being mixed, overlayed, or filtered to produce a central audio stream 208. In the example embodiment depicted in FIG. 2, the information handling device 201 is also running a remote conference application 209 that is active in a remote conference with one or more remote devices (not shown). The audio stream aggregation application 202 is in communication with, operably coupled to, or otherwise integrated into the remote conference application 209, such that the central audio stream 208 is communicated to the remote conference application 209 for use as the audio stream for the remote conference. The remote conferencing application 209 receives the central audio stream 208 and may transmit it to remote conference participants.

Embodiments provide for securely binding secondary audio devices to the information handling device, for example, through secure authentication of secondary audio devices. According to embodiments, an information handling device configured to communicate with secondary audio devices through Bluetooth may discover and selectively connect with Bluetooth enabled devices. In addition, embodiments provide that an information handling device configured to communicate using Wi-Fi may discover, authenticate, and selectively connect with located Wi-Fi enabled devices. According to embodiments, an information handling device may act as a host and may perform certain security operations to selectively allowing secondary audio devices to connect with the information handling device. As an illustrative and non-restrictive example, a host may send each located secondary audio device a pass code or authentication code, and may only accept connections from secondary audio devices that responded with the correct pass code or authentication code. For example, an authentication code may include, but is not limited to, an encryption key, password, SSID, remote conference code, or Bluetooth passkey.

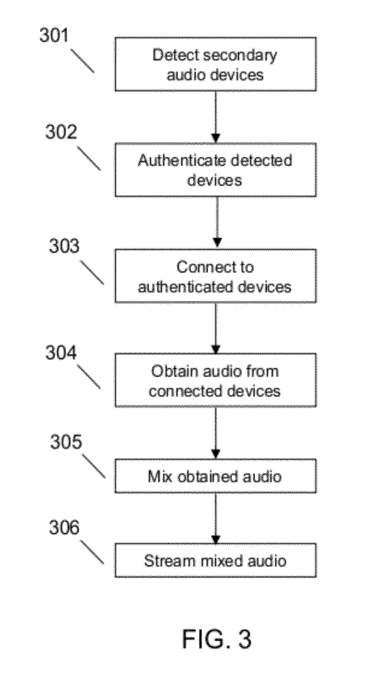

Referring to FIG. 3, therein is depicted an example flow diagram of audio aggregation software operation according to an embodiment. The audio aggregation software detects available secondary audio devices 301, authenticates detected secondary audio devices 302, and connects to authenticated devices 303. The audio aggregation software obtains audio 304 captured by the secondary audio devices and the information handling device. The audio is mixed 305 and streamed 306 to one or more audio receivers. According to embodiments, an audio receiver may be any receiver capable of handling a transmitted audio stream, including, but not limited to, software applications, drivers, audio capturing devices, audio handling devices, or program modules.

Different audio capturing devices, such as notebook computers, tablet computers, and cell phones may capture, stream, or transmit audio data with different latencies. Audio data received at an information handling device according to embodiments may synchronize the various audio streams as part of processing and mixing the separate audio streams into a comprehensive audio stream. Illustrative and non-limiting examples provide that the information handling device may synchronize audio input before mixing, or may perform an audio test of connected devices to learn device latencies, or may synchronize the various audio streams as an independent processing step.

In addition, audio capturing devices may experience certain audio effects, such as echo or picking up another individual's voice besides the main user of the audio capturing device. Embodiments provide that the information handling device may process received audio to eliminate echo or filter unintended sound detected by one or more particular audio capturing devices. As a non-limiting example, if a user is talking through an audio capturing device, the information handling device may transmit the audio from that audio capturing device and may filter out that user's voice from the other participating audio capturing devices.

Embodiments provide for an audio aggregation application running on an information handling device for capturing audio streams from secondary audio devices also running a form of audio aggregation software. An illustrative and non-restrictive example provides that an information handling device according to an embodiment may run the audio aggregation application in a “host” mode, wherein the information handling device is designated as the receiver of audio data from secondary audio devices. In addition, the secondary audio devices may be running individual instances of the audio aggregation application in a “client” mode configured to send audio data captured by a device microphone to the device running the application in “host” mode. As such, embodiments provide that a device may act as either an information handling device or as a secondary audio device depending on the operational mode of the audio aggregation application running on the device. For example, a cell phone may be running an audio aggregation application as a client while a notebook computer may be running the application as a host. In this example, audio captured by the cell phone will be sent to the notebook computer. Alternatively, the notebook computer may later launch the application as a client and the cell phone may run the application as a host. As such, sound captured by the notebook computer may be sent to the cell phone, which, in this alternative example, is operating as the information handling device.

In addition, embodiments provide for separate audio aggregation applications configured for secondary and information handling devices. For example, a main audio aggregation application would run on the information handling device, while client audio aggregation applications would run on the secondary audio devices. The main audio aggregation application would have the capability, according to embodiments, to locate and authenticate secondary audio devices, receive audio from secondary audio devices, mix and process received audio, aggregate received audio, and send aggregated audio to one or more audio stream receivers, such as applications, drivers, audio components, program modules, or other information handling devices.

According to embodiments, the information handling device may selectively process and mute audio streams obtained from secondary audio devices. For example, the information handling device may select to mute sound coming from a particular cell phone secondary audio device so that sound captured from that particular cell phone is not transmitted in the aggregated audio stream. Embodiments provide that the information handling device may mute a secondary audio device by either not letting the sound from the device in or by not letting it out as part of the aggregated audio stream. In another example, one secondary audio device may be capturing background noise that is lowering the quality of the audio stream being received from that device at the information handling device. According to embodiments, the information handling device, through the audio aggregation application, may selectively apply noise-filtering functions on the audio stream from the particular secondary audio device to remove the background noise.

According to embodiments, information handling and secondary audio devices may be any devices capable of handling audio and running an audio aggregation application according to embodiments. Illustrative and non-restrictive examples of such information handling devices include notebook computers, tablet computers, cell phones, smart phones, and desktop PC's, or some combination thereof. In addition, the communication methods for the sending and receiving of audio data may be any communication method capable of handling such audio information, including, but not limited to, LAN, WLAN, PAN, and telephone networks, or some combination thereof. Non-limiting examples of specific networks which may be utilized according to embodiments include, but are not limited to, Bluetooth, Wi-Fi, wireless USB, 3G, and 4G.

Embodiments provide that the information handling device and audio aggregation application according to embodiments may be used for various functions, including the collection, processing, mixing, and transmission of audio streams from various sources. For example, an information handling device according to embodiments may be configured to listen to one or more connected devices, act as a host of a remote conference application (e.g., VoIP application, such as Skype®), or act as an audio stream collector or processor, or any other function wherein an information handling device may be used to obtain audio from various sources and process or transmit the obtained audio as one or more audio streams.

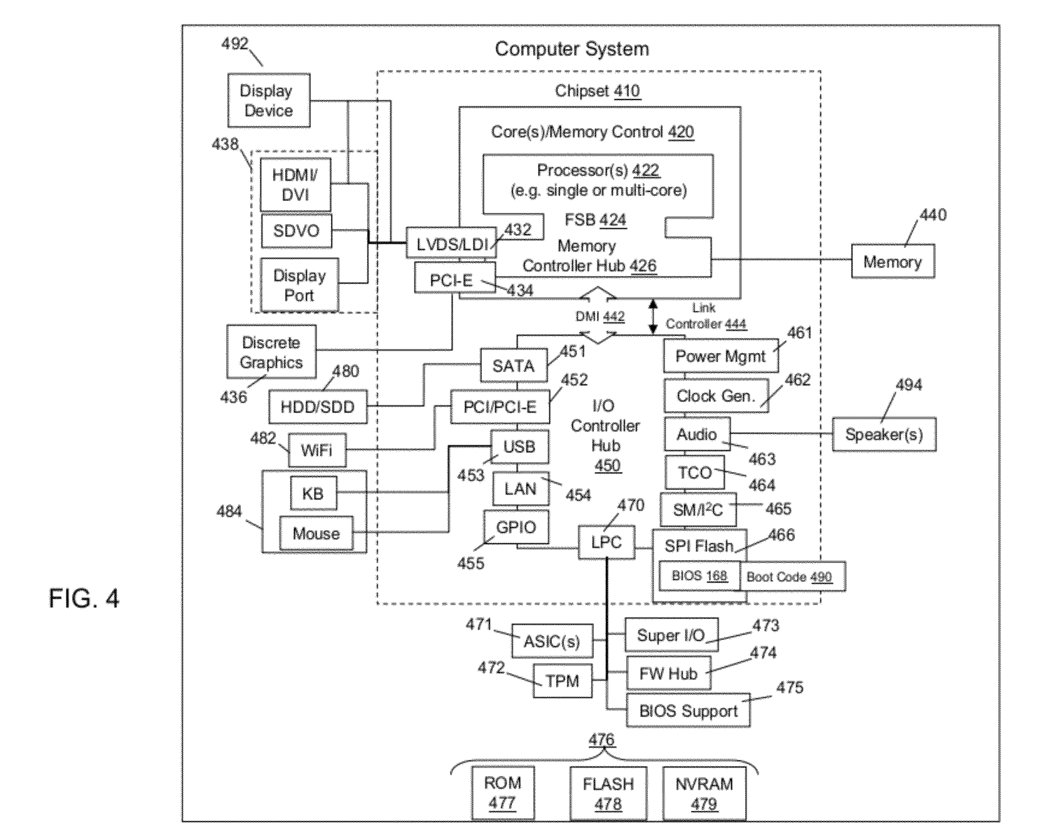

While various other circuits, circuitry or components may be utilized, FIG. 4 depicts a block diagram of one example of information handling system circuits, circuitry or components. The example depicted in FIG. 4 may correspond to computing systems such as the THINKPAD series of personal computers sold by Lenovo (US) Inc. of Morrisville, N.C. However, as is apparent from the description herein, embodiments may include other features or only some of the features of the example illustrated in FIG. 4.

The example of FIG. 4 includes a so-called chipset 410 (a group of integrated circuits, or chips, that work together, chipsets) with an architecture that may vary depending on manufacturer (for example, INTEL, AMD, ARM, etc.). The architecture of the chipset 410 includes a core and memory control group 420 and an I/O controller hub 450 that exchanges information (for example, data, signals, commands, et cetera) via a direct management interface (DMI) 442 or a link controller 444. In FIG. 4, the DMI 442 is a chip-to-chip interface (sometimes referred to as being a link between a “northbridge” and a “southbridge”). The core and memory control group 420 include one or more processors 422 (for example, single or multi-core) and a memory controller hub 426 that exchange information via a front side bus (FSB) 424; noting that components of the group 420 may be integrated in a chip that supplants the conventional “northbridge” style architecture.

In FIG. 4, the memory controller hub 426 interfaces with memory 440 (for example, to provide support for a type of RAM that may be referred to as “system memory” or “memory”). The memory controller hub 426 further includes a LVDS interface 432 for a display device 492 (for example, a CRT, a flat panel, a projector, et cetera). A block 438 includes some technologies that may be supported via the LVDS interface 432 (for example, serial digital video, HDMI/DVI, display port). The memory controller hub 426 also includes a PCI-express interface (PCI-E) 434 that may support discrete graphics 436.

In FIG. 4, the I/O hub controller 450 includes a SATA interface 454 (for example, for HDDs, SDDs, 480 et cetera), a PCI-E interface 452 (for example, for wireless connections 482), a USB interface 453 (for example, for input devices 484 such as a digitizer, keyboard, mice, cameras, phones, storage, other connected devices, et cetera.), a network interface 454 (for example, LAN), a GPIO interface 455, a LPC interface 470 (for ASICs 474, a TPM 472, a super I/O 473, a firmware hub 474, BIOS support 475 as well as various types of memory 476 such as ROM 477, Flash 478, and NVRAM 479), a power management interface 461, a clock generator interface 462, an audio interface 463 (for example, for speakers 494), a TCO interface 464, a system management bus interface 465, and SPI Flash 466, which can include BIOS 468 and boot code 490. The I/O hub controller 450 may include gigabit Ethernet support.

The system, upon power on, may be configured to execute boot code 490 for the BIOS 468, as stored within the SPI Flash 466, and thereafter processes data under the control of one or more operating systems and application software (for example, stored in system memory 440). An operating system may be stored in any of a variety of locations and accessed, for example, according to instructions of the BIOS 468. As described herein, a device may include fewer or more features than shown in the system of FIG. 4.

Embodiments may be implemented in one or more information handling devices configured appropriately to execute program instructions consistent with the functionality of the embodiments of the invention as described herein. In this regard, FIG. 4 describes a non-limiting example of such an information handling device. Embodiments may be implemented using a variety of systems, such as desktops, workstations, servers, smartphones, slates, tablets, and the like.

As will be appreciated by one skilled in the art, various aspects may be embodied as a system, method or computer program product. Accordingly, aspects may take the form of an entirely hardware embodiment or an embodiment including software and/or hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more non-signal computer readable medium(s) may be utilized. The non-signal computer readable medium may be a computer readable storage medium. A computer readable storage medium may be, for example, an electronic, magnetic, optical, electromagnetic, infrared, or semiconductor system, apparatus, or device, or any suitable combination of the foregoing. More specific examples (a non-exhaustive list) of a computer readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a computer readable medium may be transmitted using any appropriate medium, including but not limited to wireless, wireline, optical fiber cable, RF, etc., or any suitable combination of the foregoing.

Computer program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented at least in part by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

The computer program instructions may also be stored in a computer readable medium that can direct a computer, other programmable data processing apparatus, or other device(s) to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other device(s) to cause a series of operational steps to be performed on the computer, other programmable apparatus or other device(s) to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying drawings, it is to be understood that this description is not limiting and that various other changes and modifications may be affected therein by one skilled in the art without departing from the scope or spirit of the disclosure.

What is claimed is:

1. A system comprising:
a host audio aggregation application running on an information handling device and being configured to obtain audio transmitted by at least one secondary audio device external to the information handling device; and
at least one central audio stream generated by the host aggregation application by mixing the audio transmitted by the at least one secondary audio device and obtained by the host audio aggregation application;
wherein the host aggregation application is configured to send the at least one central audio stream to at least one audio receiver.

2. The system according to claim 1, wherein the audio obtained from the at least one secondary audio device by the information handling device is obtained via a personal area network (PAN).

3. The system according to claim 1, wherein the audio obtained from the at least one secondary audio device by the information handling device is obtained via a wireless local area network (WLAN).

4. The system according to claim 1, wherein the information handling device comprises a notebook computer.

5. The system according to claim 1, wherein the at least one secondary audio device comprises a phone.

6. The system according to claim 1, wherein the at least one audio receiver comprises a remote conference application.

7. The system according to claim 1, wherein the host audio aggregation application is configured to detect at least one secondary audio device.

8. The system according to claim 7, wherein the host audio aggregation application is configured to authenticate each detected at least one secondary audio device.

9. The system according to claim 8, wherein authentication comprises the host audio aggregation application receiving an authentication code from each detected at least one secondary audio device.

10. The system according to claim 1, wherein the at least one secondary audio device is in proximity to the information handling device.

11. A method comprising:
running a host audio aggregation application on an information handling device, the host audio aggregation application being configured to obtain audio transmitted by at least one secondary audio device external to the information handling device;
generating at least one central audio stream via the host aggregation application by mixing the audio transmitted by the at least one secondary audio device and obtained by the host audio aggregation application;
wherein the host aggregation application is configured to send the at least one central audio stream to one or more audio receivers.

12. The method according to claim 11, wherein the audio obtained from the at least one secondary audio device by the information handling device is obtained via a personal area network (PAN).

13. The method according to claim 11, wherein the audio obtained from the at least one secondary audio device by the information handling device is obtained via a wireless local area network (WLAN).

14. The method according to claim 11, wherein the information handling device comprises a notebook computer.

15. The method according to claim 11, wherein the at least one secondary audio device comprises a phone.

16. The method according to claim 11, wherein the at least one audio receiver comprises a remote conference application.

17. The method according to claim 11, wherein the host audio aggregation application is configured to detect at least one secondary audio device.

18. The method according to claim 17, wherein the host audio aggregation application is configured to authenticate each detected at least one secondary audio device.

19. The method according to claim 18, wherein the at least one secondary audio device is in proximity to the information handling device.

20. A computer program product comprising:
a computer readable storage medium having computer readable program code embodied therewith, the computer readable program code comprising:
computer readable program code configured to run a host audio aggregation application on an information handling device, the host audio aggregation application being configured to obtain audio transmitted by at least one secondary audio device external to the information handling device;
computer readable program code configured to generating at least one central audio stream via the host aggregation application by mixing the audio transmitted by the at least one secondary audio device and obtained by the host audio aggregation application; and
computer readable program code configured to send the at least one central audio stream to one or more audio receivers via the host audio aggregation application.
